(19) United States
(12) Patent Application Publication
(10) Pub. No.: US 2019/0340570 A1
(43) Pub. Date: Nov. 7, 2019

(54) AD-HOC AUXILIARY ITEM TRANSPORT SYSTEM AND METHOD

(71) Applicant: CHARGERBACK, INC., Carson City, NV (US)

(72) Inventors: Brian Colodny, Reno, NV (US); Michael McLaughlin, Gardnerville, NV (US)

(21) Appl. No.: 16/404,714

(22) Filed: May 6, 2019

Related U.S. Application Data
(60) Provisional application No. 62/667,768, filed on May 7, 2018.

(51) Int. Cl. G06Q 10/08; G06Q 20/32

(52) U.S. Cl. CPC G06Q 10/0832; G06Q 20/322; G06Q 10/0833; G06Q 10/08345

(57) ABSTRACT

The invention provide for an item transport management system, comprising at least one server having a processor configured to, receive a pick-up request from a client device to pick up at least one package, the pick-up request including at least a departure location and at least one service request to service at least one item in the at least one package, and transmit a service shipping label to the departure location, the service shipping label being used to direct the package to a service location.

### CROSS-REFERENCE TO RELATED APPLICATION

This application claims priority to U.S. Provisional Patent Application No. 62/667,768, filed May 7, 2018 and entitled “Ad-Hoc Auxiliary Item Transport System and Method,” which is hereby incorporated herein by reference in its entirety.

### COPYRIGHT

A portion of the disclosure of this patent document contains or may contain material subject to copyright protection. The copyright owner has no objection to the photocopy reproduction of the patent document or the patent disclosure in exactly the form it appears in the Patent and Trademark Office patent file or records, but otherwise reserves all copyright rights.

### FIELD OF TECHNOLOGY

The technology of the present application relates to the transporting of items, and more particularly to ad-hoc auxiliary on-demand transporting of items from a departure location to one or more destination locations.

### BACKGROUND

Historically, individuals have often faced challenges and inconvenience transporting items when traveling from one location to another. There have been what seems like ever-increasing safety, physical, and policy-based restrictions placed on travelers with respect to their luggage, baggage, and carry items. And even where individuals have opted to transport their items as part of their travel experience, this has often been met with inconvenience, delay, and financial costs. This problem has been long standing and well understand, but little has been done to try and address this challenge, often resulting unpleasant travel experiences.

In the case of air travel, passengers often first face challenges before even leaving their home. At the time they packed their belongings and other items they wish to bring with them, they were typically placed in a position where they had to decide how much they must carry with them, to wonder whether or not they will exceed check-in baggage weight limitations, and to consider whether the bag or bags they do carry on would fit in the restricted physical area for carry-on's. A miscalculation with any of these sometimes resulted in damage to what was carried, additional cost for exceeding weight restriction, inconvenience and delays due to having to check carry-on's after boarding the plane, or abandonment of some of their items.

Airlines have been hard-pressed to provide proactive solutions to these problems. Some attempted to discourage excess baggage by charging substantial fees based on exceeding weight or size limitations. Travelers then often found themselves facing a decision at the check-in counter where, under time constraints, they could either discard some of their items or miss their plane. Not so surprisingly, because they had no other option, passengers generally spent time trying to reallocate belongings across their check-in bags, carry-on bags, friends bags, or all of these, and often ended up simply discarding some of their belongings in the trash.

If this weren't enough, as passengers proceed through the security check point at the airport, they sometimes discovered that they inadvertently brought with them forbidden items, such as, for example, pocket knives or scissors. Here again, the passenger was faced with a decision whether to abandon the item or take the time to exit the security check point, return to the airline, and have the item checked in, sometime resulting in the passenger missing their flight. It is well known that these security checkpoints end up collecting thousands and thousands of valuable forbidden items every year with little chance of recovery by the traveler.

But it didn't end there. When the passenger arrived the gate and boarded the plane, that passenger again sometimes found themselves faced with another item transport decision. Depending on their seating position, passengers sometimes boarded the plane only to find that all overhead compartments were taken, meaning they were forced to check their bags, often while they are jammed up in the back of the plane and inconveniencing other passengers. To avoid that inconvenience, passengers sometimes resorted to discarding some of their items so that they were able to fit their belonging in smaller overhead spaces, under the seats in front of them, or both. For carried un-packaged items, these items were often damaged as a result of being forced into over-capacity, ill-shaped compartments. In addition, the excessive use of under-the-seat storage reduced leg room which often resulted in degrees of discomfort during flight, sometimes to a severe degree.

Moving about the airport further presented annoyances. Dragging multiple carry-on bags, along with other hand-carried item through busy airports with limited seating, especially when rushing to make connecting flights, was at best inconvenient, and at worst slowing enough to cause some passengers to miss their plane.

Upon arrival, passengers were generally inconvenienced having to recover their checked luggage from a baggage claim area, which often resulted in delay, and sometimes resulted in lost, and sometimes never recovered, luggage. Where a passenger was forced to check a bag they intended to carry, they were often carrying due to a time constraint, such as making a meeting soon after landing. The delay from having to recover a bag from baggage claim sometimes resulting in the passenger being late for or missing their appointment. From baggage claim, travelers were often then confronted with the capacity limitations of taxi services. This problem is further exacerbated with the rise of rideshare solution which has not allowed riders to select vehicles without incurring substantial upcharges. Because rides are ordered sight unseen, it is not until the passenger has waited some period of time that they can determine whether or not the vehicle can accommodate their items.

In the case where a traveler is returning, they typically further had to face the prospect of bags filled with dirty clothes upon arriving home—an ill-reward for having fought with their item transport during their travel experience. For business travelers, they were often forced to take wrinkled clothing resulting from being stuffed into bags, whether dirty or not, to a dry cleaner to at least be pressed, taking valuable time out of their day. In addition, dirty clothes sometimes had all manner of scent or soil, which was then often transferred to the clean clothes contained in the same bag, often resulting in the need to launder or dry clean the entirety of the contents.

Business travelers often faced additional challenges with their items. For example, it was very common for travelers with appointments the day of their departure to have to haul their carry-on bags into meetings, conferences, offices, and all manner of activities. This was annoying, burdensome, and for some, embarrassing and disruptive to making an impression. This also increased the probability of items being inadvertently left behind. Further, when business travelers are traveling for events such as conferences, they often found themselves having to try to transport some of the conference materials, displays, or demos. While this might have been prudent on the arrival leg, it is typically nothing more than a burden and annoyance on the return leg, where time is typically not of the essence. Finally, business travelers often have multiple legs on the same business trip and had to transport multiple items along the duration of the trip, even where the items were irrelevant for the given leg of travel.

### Overview

The present invention provides other hardware configured to perform the methods of the invention, as well as software stored in a machine-readable medium (e.g., a tangible storage medium) to control devices to perform these methods.

In one embodiment, the invention provide for an item transport management system, comprising at least one server having a processor configured to, receive a pick-up request from a client device to pick up at least one package, the pick-up request including at least a departure location and at least one service request to service at least one item in the at least one package, and transmit a service shipping label to the departure location, the service shipping label being used to direct the package to a service location.

In another embodiment, an ad-hoc auxiliary item transport system, comprising a central server having a processor configured to: receive a pick-up request from a client device to pick up at least one package, the pick-up request including at least a departure location and at least one service request to service at least one item in the at least one package, and determine a first destination address based on the at least one service request. The method further comprise a shipment server configured to: determine a first charge amount based on the departure location, the first destination address, and the at least one service request, transmit a first payment request to the client device for payment of the first charge amount, receive a payment of the first charge amount, transmit as shipping label to the departure location, the shipping label including the first destination address, and transmit a first pick-up notification to a shipping server, the first pick-up notification including at least the first destination address.

In another embodiment, a method for ad-hoc auxiliary item transport, comprises receiving a pick-up request for at least one package, the pick-up request having a departure location and at least one service request, obtaining a departure address associated with the departure location, determining a charge amount, the charge amount based on at least the departure address and destination address, transmitting a request to pay the charge amount, receiving payment of the charge amount, transmitting a shipping label to the departure location, the shipping label having the destination address, transmitting a pick-up notification to a shipping company for pick-up of the at least one package at the departure address, and facilitating delivery of the at least one package to the destination address.

These and other features will be presented in more detail in the following detailed description of the invention and the associated figures.

### BRIEF DESCRIPTION OF THE DRAWINGS

The accompanying drawings, which are incorporated into and constitute a part of this specification, illustrate one or more example embodiments and, together with the description of example embodiments, serve to explain the principles and implementations.

In the drawings:

FIG. 1 illustrates an example of an ad-hoc auxiliary item transport system.

FIG. 2 illustrates another example of an ad-hoc auxiliary item transport system.

FIG. 3 illustrates an example ad-hoc auxiliary item transport method.

FIG. 4 illustrates another example ad-hoc auxiliary item transport method.

FIGS. 5A and 5B illustrate a flowchart yet another example ad-hoc auxiliary item transport method.

FIGS. 6A and 6B illustrate a flowchart of still another example ad-hoc auxiliary item transport method.

FIG. 7 illustrates a block diagram of a computing device according to one embodiment.

FIG. 8 illustrates a block diagram of a computing device according to another embodiment.

### DESCRIPTION OF EXAMPLE EMBODIMENTS

The applicants believe that they have discovered at least one or more of the problems and issues with item transportation systems and methods noted above as well as advantages variously provided by differing embodiments of the ad-hoc auxiliary item transportation system and method disclosed in this specification.

The following description provides examples, and is not limiting of the scope, applicability, or configuration to be set forth in future claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

In some embodiments, the ad-hoc auxiliary item transport system and method provides for the ad-hoc transport of one or more items from a departure location to a service destination location, a final destination location, or both. Departure locations can include locations not typically serving as shipping drop offs or shipping origins, such as an airline baggage check-in, an airport security checkpoint, an airport gate, a jet bridge, an airplane cabin, a lodging location such as a hotel or resort, and the like.

In some instances, a shipper-associated inactive pre-label contains data that can be associated with a particular transport container, shipping event, or both. The inactive pre-label can be activated by methods such as, for example, transmission of data to a shipping system or shipper system interface, the data including at least a data portion triggering activation. In some implementations, the triggering data portion includes one or more of an activation flag, a paid confirmation indication, a final shipping destination location, an origin location, an activation argument, or an activation api call.

In certain instances, transport containers or packaging are provided to the departure location for the packaging of items for transport. In some cases, inactive pre-labels are affixed to the transport container or packaging in advance of delivery to the departure location. In other cases, inactive pre-labels are affixed and activated at or near the time of shipping. In still other cases, activated labels are printed at the departure location at or near the time of shipping. In some embodiments, the shipper will scan the active pre-label during at least a portion of the item transport to determine one or more destinations.

In some implementations, a mobile app running on a mobile device receives an image of the pre-label and transmits at least a portion of the pre-label data to a remote service for activating the table. One skilled in the art will appreciate that other technologies can be employed to accomplish the same objective, including barcode readers, QR code readers, and the like. The app can store or request one or more of a preferred destination location, a service request, such as laundering or dry cleaning (e.g. services such as cleaning, steaming or ironing), and a payment authorization. In some cases, one or more of destination information or payment information are stored on the mobile device in advance for easier transmission to the remote service. In the case where method of payment information is already stored on the device, selection of a payment authorization option may be sufficient for label activation logic that is payment-dependent. The app can, in certain cases, determine location, which location can then be used by the app, the remote services, or both to determine, at least in part, the shipment origin, the shipping rate, the protocols of the departure location, and the like. For some implementations, the app, once the current location is determined, can display the related ad-hoc auxiliary item transport system services that are available within a set proximity.

It will be appreciated by those of skill in the art that many of the features and functions available in the app can be made available via a web interface that can run in one or more of mobile devices, computer browsers, and the like.

In some instances, label activation does not occur unless and until one or more pre-conditions are met, such as, for example, authorized payment in full, delivery of conforming destination information, and the like. Activation validation can occur on a client device, at the application server, or at a remote service location.

The ad-hoc nature of the system and methods relates to the ability of a traveler to initiate an auxiliary item transport on-demand at location not otherwise historically amenable to shipping of items. The auxiliary nature of the system and methods relates to the alternative characteristic of the shipping in contrast to the primary transport which includes those methods that involve the passenger retaining custody or near-custody of their items during travel. Service destinations can include, for example, dry cleaners, laundering facilities, and the like.

Multiple destination transport activities can include, for example, first transporting a traveler's dirty apparel from a departure location, such as a hotel, to a service destination such as a dry cleaner or laundering facility. In some instances, the ad-hoc auxiliary item transport system determines an appropriate service destination based on one or more factors such as price, distance from departure location, distance from final destination location, traveler's preference, and the like. In some implementations, a final destination shipping label is included in the delivery to the service destination. In other implementations, the service destination is given access to and prints the shipping label.

The foregoing has outlined rather broadly the features and technical advantages of examples. The conception and specific examples disclosed may be readily utilized as a basis for modifying or designing other structures for carrying out the same purposes of the present disclosure. Features which are believed to be characteristic of the concepts disclosed herein, both as to their organization and method of operation, together with associated advantages will be better understood when considered in connection with the accompanying figures. Each of the figures is provided for the purpose of illustration and description only, and not as a definition of the limits of the claims included herein now or as amended during prosecution. Thus, the scope of a given claim is to be determined by the claim as issued and not by whether it addresses an issue set forth in the above Background or includes a feature set forth in this Brief Summary.

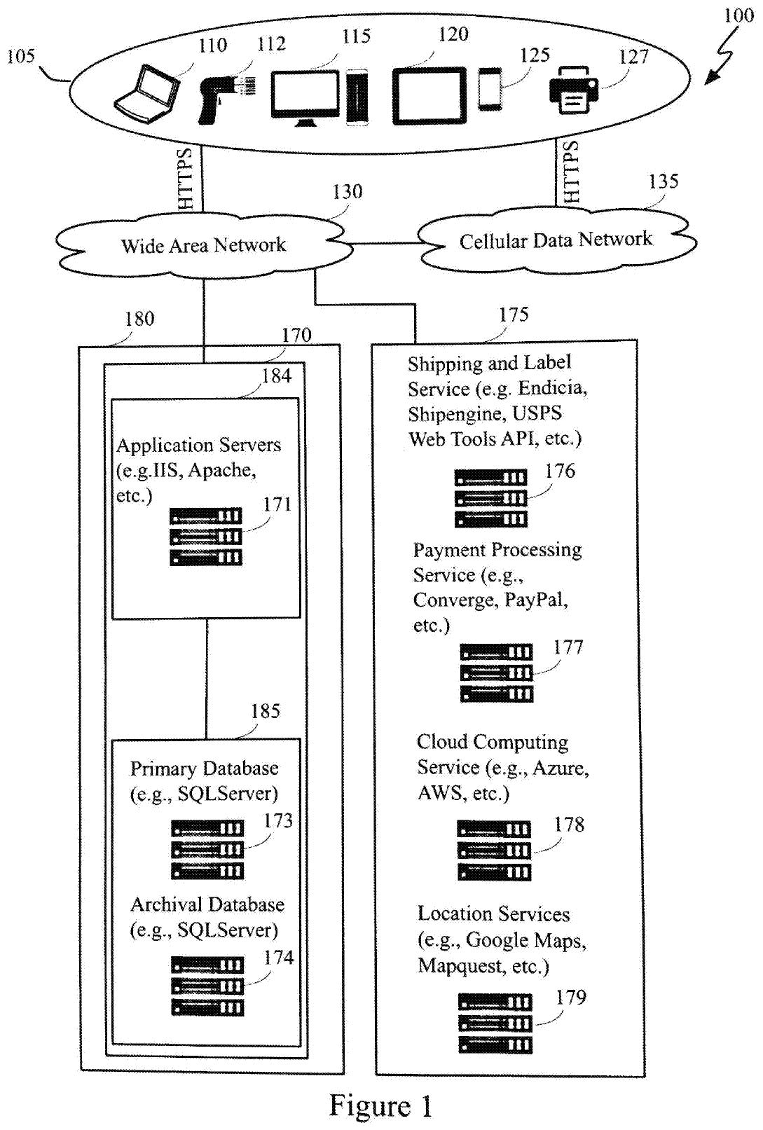

Referring now to FIG. 1, an example of an ad-hoc auxiliary item transport system, the systems and methods disclosed can be implemented in a digital processing environment 100. The present systems and methods can also run on different architectures that may include a LAN, WAN, desktop computer, laptop computer, mobile devices, peripherals, scanners, printers, clustered, or networked server computers, etc. FIG. 1 is only an example, however, as many other computing arrangements can support the systems and methods disclosed in this specification. Further, the system shown in FIG. 1 can utilize a wide variety of differing sub-systems in order to support the disclosed systems and methods.

For example, in one embodiment, the implementation of the time segmented content processing system and methods runs in the Windows® environment. In another embodiment, the software is implemented to run in other environments, such as Linux® or UNIX®, and may run on any hardware having enough power to support timely operation of software such as that identified in FIG. 1. In certain instances, computers are deployed as virtual instances rather than physical computers.

In some embodiments, a networked environment 180 includes one or more storage technologies 185, and application processing technologies 184. In certain embodiments, one or more services external to the networked environment 175, such as shipping and label services 176, payment processing services 177, cloud computing services 178 and location services 179 provide additional or distributed functionality. In other embodiments, one or more of these external services are provided within the networked environment.

In some deployments, application web servers 171 are instances of IIS® with implementations of one or more of ASP.NET, Java, JScript, AngularJS, HTMLS, or the like. In other instances, application web servers 171 are instances of Apache® with PHP packages and frameworks, such as, for example Laravel®, deployed with fastcgi module and php configuration enabled. Those skilled in the art will appreciate that other web server, application server technologies, and frameworks can be used as an alternative to IIS® and Apache®. Application web servers 171 communicate client devices and instances, over HTTP/HTTPS. Other protocols may be used depending on the technology stack deployed. In some instances, the application web servers 171 can communicate with the database instances 185 via, for example. the transmission of SQL requests, T-SQL requests, JSON (JavaScript Object Notation), and the like.

Database servers 185, in some embodiments, can deploy one or more relational databases with traditional schema restrictions such as Microsoft SQLServer®, MySQL®, and SQLLite. In some instance, Transact-SQL can be used to interact with the SQL database. Alternatively, schemaless, non-relational databases, such as MongoDB, can be deployed, storing information as documents rather than as records in tables. In certain implementations, the database deployment can be implemented in a sharded cluster. The shards store the data, providing high availability and data consistency, with each shard including a replica data set. The replica sets are a group of database instances that host the same data set. One database instance for each of the primaries receives all write operations. All other instances, secondaries, apply operations from the primary so that they have the same data set. The primaries accept all write operations from clients. In certain implementations, the application web servers 185 interface with one or more cloud services, such as, for example, Endicia, Converge, Azure, or Google Maps, over, for example, a REST API using a proprietary service API protocol using, for example, JSON objects. In some instances, one or more cloud services are third party services with associated fees.

Computing devices of various types 105 can communicate with one another, with the system server infrastructure 180 or both via a network 130 over a communication protocol, such as, for example, TCP/IP. The network 130 can be a wide area network that is part of a remote access network, a global network (e.g., the Internet), a worldwide collection of computers, gateways that currently use respective protocols (TCP/IP, UDP, etc.) to communicate with one another, and the like. All computing devices can pass information as one or more of unstructured data, structured files, structured data streams such as, for example, XML, structured data objects, and/or structured messages. Client computing devices 110, 115, 120, 125 may communicate over various protocols such as, for example, UDP, TCP/IP, and/or HTTPS. In some instances, certain computing devices 105 can communicate via a cellular data network 135. In some implementations, bar code scanners 112 interface with one or more client computing devices 110, 115, 120, 125 or the system server infrastructure 180 transmitting, raw or pre-processed transport data from a shipping label. In some instances, a printer capable of printing labels 127 is communicatively coupled to one or more client computing devices 110, 115, 120, 125 or the system server infrastructure 180, receiving label images and label printing instructions.

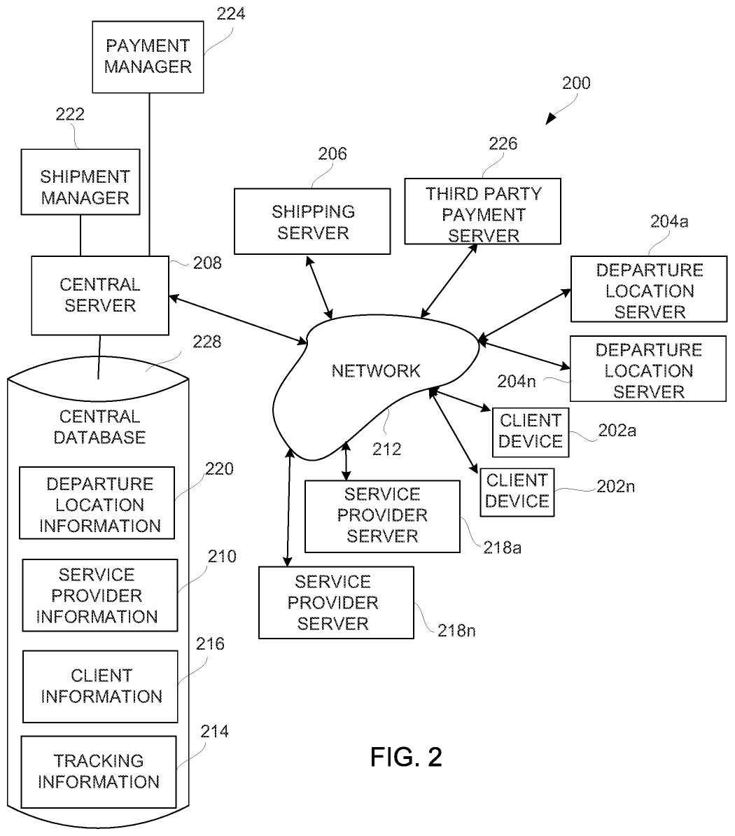

FIG. 2 illustrates another example of an ad-hoc auxiliary item transport system. In some embodiments, a relational data model consisting of tables, fields, relations, and other mechanisms such as triggers and stored procedures, can be deployed on one or more data base servers 185 (e.g., see FIG. 1). This relational structure can be tailored to specific types transport configurations. Tables can include, among others for example, a Password table for authentication, a Shipper table for storing and updating shipper-related and departure location-related data, a Traveler table for storing and updating item-related and traveler-related data, and a Chain of Custody or tracking table for storing event tracking data.

The system 200 may have a plurality of client computing devices 202a, 202n (where n is an integer) configured to communicate with a central server 208 via network 212 to transmit a service request. The service request may be a request to, such as a pick-up request, to pick up at least one package or a service request to service at least one item in the at least one package. Client computing devices 202a-n and central server 208 may be connected to network 212 via any known wired or wireless manner. Client computing devices 202a-n may be any computing device such as a desktop computer, laptop, netbook, as well as any mobile computing device such as mobile (e.g., cellular) phones, media players, personal digital assistants (PDAs), and the like as also discussed above with reference to FIG. 1. Client information 216 may be stored in central database 228 of central server 208. Client information may be information or data such as contact information (e.g. name, phone number, address, electronic mail address, and the like), client preferences (e.g. using the closest service provider to the departure or destination location, selecting the less expensive service provider, and the like), detailed description of the at least one package (e.g. description of items in the package, color, shape, manufacturer, and the like), and any other necessary or desired client information or data.

The system 200 may have a departure location server 204a-n and a service provider server 218a-n configured to communicate with the central server 208 via network 212, via any known wired or wireless manner, to transmit data or information and conduct any other transactions such as receive shipping documents, authentication of the customer, and the like. Departure location information 220 and service provider information 210 may be stored in a central database 228 of central server 208. Departure location information 220 stored in central database 228 many include information or data such as contact information (e.g. address, telephone number, contact person, and the like), pick-up location or instructions for at least one package (e.g. location in or around the departure location where the at least one package will be stored for pick-up, whether the package is fragile, and the like), client information, detailed description of the at least one package (e.g. description of items in the package, color, shape, manufacturer, and the like), and any other information necessary or desired to facilitate pick-up of the at least one package. Service provider information may include information or data such as contact information (e.g. address, telephone number, contact person, and the like), services provided, duration of time to complete a service, pricing for the service, pick-up location or instructions for at least one package (e.g. location in or around service provider location where the at least one package will be stored for pick-up, whether the package is fragile, and the like), client information, detailed description of the at least item or the at least one package (e.g. description of items in the package, color, shape, manufacturer, and the like), and any other information necessary or desired to facilitate completion of services and pick-up of the at least one package requested from the client.

When a client device 202a-n desires to have at least one package picked up from departure location 204a-n, the client may transmit a service request to central server 208 via network 212. The departure location 204a-n may be any location the client 202a-n desires for the at least one packages to be picked up from. For example, departure location 204a-n may be the client's home, hotel, airport, or any other desired location.

The service request may have at least a departure location from which to pick up the at least one package and a destination location to deliver the at least one package. Information associated with the departure location may be obtained from departure location information 220 in central database 228. Information associated with the client device 202a-n may be obtained from client information 216 in central database 228. Service request may also have any other necessary or desired information such as the number of packages, size of each package, weight of the at least one package, image of the at least one package, color of the at least one package, or any special instructions (e.g. whether the package is fragile, includes live animals, is heavy, use of a specific shipper, and the like).

The client 202a-n may transmit the service request by any known means. In one embodiment, the client device 202a-n may go to a website, of central server 208 and/or shipping server 206, and enter in any desired information to carry out or complete the service request. In another embodiment, an image, indicia, or code may be provided on at least one transport container. Client device 202a-n may then use the image or code on the transport container to transmit the service request. For example, the transport container may have a bar code, QR code, or any other indicia that the client device 202a-n may scan to transmit the service request. In another example, the client device 202a-n may input a code on the transport container in the central server's 208 website. By scanning or inputting the image, indicia, or code, the transport container may be associated with client device 202a-n.

Central server 208 may have a shipment manager 222. Shipment manager 222 configured to communicate with shipping server 206 via network 212. Shipping server 206 may be any company that performs shipping services such as UPS™, United States Postal Service, DHL™, FedEx™, common carrier, local delivery service, or any other company that provides similar services. In one embodiment, based on at least the departure location and destination location, shipment manager 222 may determine a service charge for delivery of the at least one package. In another embodiment, the charge for delivery of the at least one package may be based on at least the departure location, destination location, and the number of packages to be picked-up and delivered. In still another embodiment, the charge for delivery of the at least one package may be based on at least the departure location, destination location, number of packages to be picked-up and delivered, weight of the package, and whether the special instructions requires additional costs.

The service charge may also include any extra shipping services or shipping options such as the purchase of insurance, delivery confirmation, expedited delivery, and the like. The service charge may also include any service requests, as further discussed below, requested by client 202a-n. For example, if the client requests laundry services, the cost of the laundry services may be included in the service charge. In another example, if the client requests a laptop computer to be fixed, the cost of fixing the laptop computer may be included in the service charge. The service charges may be obtained from service provider information 210 stored in central databased 228.

Once the service charge is calculated, an invoice or request for payment may be transmitted from central server 228 to client device 202a-n. In one embodiment, client device 202a-n may provide payment to payment manager 224 of central server 208. In another embodiment, a third party payment server 226 may be used to provide payment to central servicer 208. Although illustrated with the use of payment manager 224 and third party payment server 226, this is not intended to be limiting as payment for the service charges may be conducted by other methods. For example, client 202a-n may have the service charges charged to a credit card on file stored in client information 216 at central database 228.

In one embodiment, a plurality of transport containers may be provided to the departure locations 204a-n or service providers 218a-n. The transport containers may be used by clients 202a-n, departure locations 2014a-n, or service providers 218a-n to package or store the belongings for shipping. For example, if the client would like to ship their dirty clothes back home, they may put the dirty clothes in the transport containers rather than use their luggage. The transport container or package may then be picked up by an employee associated with the departure location 204a-n and held until picked up by a shipping company 206. In another embodiment, the transport container may be picked up by an employee associated with a shipping company 206.

In one embodiment, the transport container may be customized to the departure location 204a-n or the service provider 218a-n specifications. The specifications may include, for example, a logo, tag lines, colors, and any other indicia necessary or desired by the departure location 204a-n or the service provider 218a-n to customize the transport container.

Once payment is received at central server 208, at least one shipping label having a destination location or address may be delivered to the departure location server 204a-n. The destination location may be printed as words or may be an image, such as a barcode or QR code, printed on the shipping label. In one embodiment, the at least one shipping label may be electronically delivered to departure location server 204a-n. The shipping label may then printed and affixed or attached to the package at the departure location 204a-n. In another embodiment, if there is more than one destination for the package, a plurality of shipping labels may be printed out and attached to the package. In still another embodiment, one shipping label may have multiple destination addresses printed on the single shipping label. In this embodiment, each destination address is printed on one shipping label and affixed to the package such that the service locations do not need to print any labels for efficiency. In yet another embodiment, a shipping label may be printed at each service provider server 218a-n. The shipping label may be affixed or attached to the package at each servicer provider 218a-n when the service is completed and the package is ready for shipment to the next destination. The service provider 218a-n may recycle the original transport container or use a new transport container. Once affixed to the at least one package, the shipping label may be activated and tracked.

The service request may just request that the at least one package be delivered to the client's home address. However, in another example, the service request may have at least one service request. The service request may have at least the departure location, destination location, and at least one service request. For example, the client 202a-n may want their dirty clothes cleaned before being delivered to their home. Thus, the client 202a-n may pack their dirty laundry into a transport container provided at their departure location 201a-n and include laundry services in the service request. Central server 208 may determine a service provider 210 able to provide the laundry services.

In one embodiment, the determination to locate a suitable service provider 218a-n may be based on the client's preferences. For example, the client may request a specific service provider 218a-n. In another example, the determination may be based on how close in distance the service provider is to either the previous destination or next destination address. In another example, the determination may be based on reviews or ratings of the service provider 218a-n.

After payment is received from client 202a-n, central server 208 may deliver a shipping label having the service provider's information 210 to departure location server 201a-n. Departure location server 210a-n may print out the shipping label or documents and attach it to the at least one package. An employee from either the departure location 204a-n or a shipping company 206 may pick-up the at least one package for delivery to the service provider.

Once the clothes are laundered, the service provider 218a-n, in one embodiment, may pack the clean clothes in the original or a new transport container, print out another shipping label having the client's home address or any other destination address, and affix the shipping label to the transport container. In another embodiment, for efficiency, the client's home address may already be printed on the original shipping label. Service provider 218a-n may then transmit a completed notification to inform central server 208 that the services are complete. Central server 208 may transmit a pick-up notification to inform shipping company 206 to pick up the package for delivery to the client's 202a-n address. The completed notification and pick-up notification may be transmitted by any known methods such as electronic mail, text message, use of the shipment company's web page, telephone call, or any other notification methods. In one embodiment, the printing of the shipping labels or documents may automatically notify the central server 208, shipment manager 222, and/or shipping server 206 that the at least one package is ready for pickup.

Although described with services being cleaning or laundry services, the services may be any known service desired. For example, the service may be to mend or fix a broken object, alter clothes, or any other desired service. In fact, delivery of the at least one package to a destination location may be considered a service request as well. In one example, the service may be to fix a laptop computer. In another example, the service may be to purchase a lost charger.

Departure location server 204a-n and service provider server 218a-n may be any type of establishment such as a hotel, supermarket, airport, airline company, coffee shop, car rental company, school (e.g. primary school, university, college, and the like), cruise ship, movie theaters, parks and campgrounds, shopping centers, business centers, private residences, dry cleaner, or any other location where services may be provided. Furthermore, the establishment may also be an event, such as a football game, convention, seminar, and the like.

Central server 208 may store tracking information 214 in central database 228. Whenever the at least one package is picked up and/or delivered, the shipping server 206 may transmit tracking information or data 214 for storage in central database 228. This provides for a chain of custody of the at least one package if it is lost or misplaced. Tracking information 214 may include the name of the employee that picked up the at least one package, a timestamp of when the at least one package was picked up, a timestamp of when the at least one package was delivered, address of the pick-up and delivery locations, contact information of the person accepting delivery of the at least one package, and any other necessary or desired tracking information.

Central server 208 may periodically notify and update client 202a-n of the status of the at least one package. In one embodiment, notification may be sent at pre-determined intervals. For example, the client 202a-n may be updated every two hours. Central server 208 may transmit a pick-up notification to client device 202a-n when the at least one package is picked up from either the departure location 204a-n and/or service provider 218a-n. Central server 208 may transmit a delivered notification to client device 202a-n when the at least one package is delivered to the service provider 218a-n or to a final destination, as requested by the client 202a-n in the service request. In another embodiment, the client 202a-n may also track the at least one package from either the shipping server's 206 or central server's 208 website. Central server 208 may also monitor and determine whether and when the client 202a-n viewed the notifications.

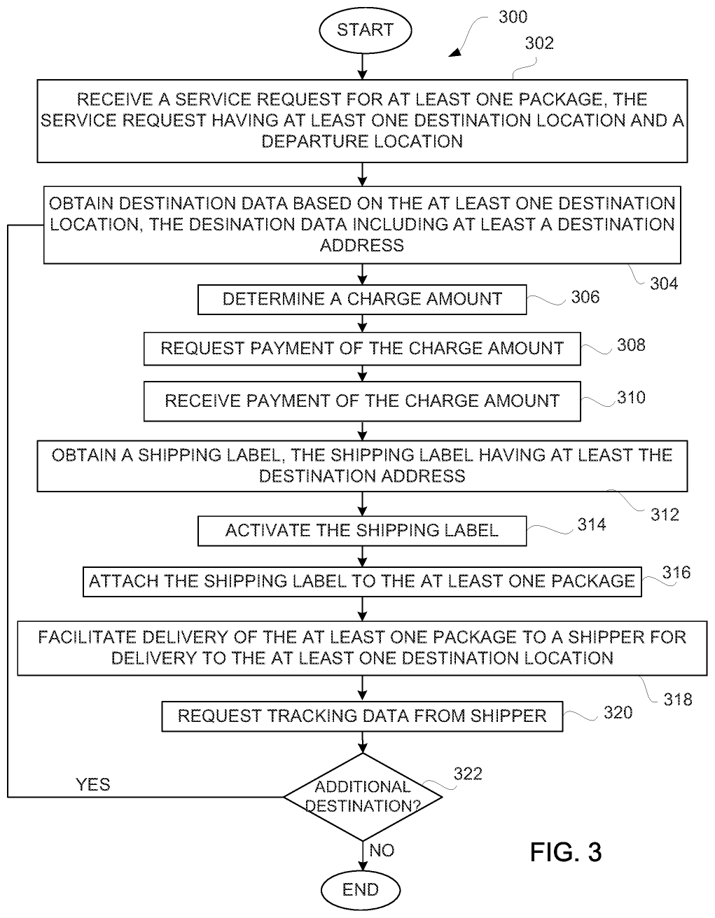

FIG. 3 illustrates an example ad-hoc auxiliary item transport method. This method is, in some instances, for use with an ad-hoc auxiliary item transport system, a memory storing data associated with one or more shipments, and one or more processors. The method 300 may be carried out, at least in part, by a portion of the system of FIG. 1 or FIG. 2, or using any combination of the components described.

Method 300 may begin with receiving a service request for at least one package, the service request having at least one destination location and a departure location at 302. The service request may be transmitted from a client or customer device, such as client device 202a-n illustrated in FIG. 2, to a central server, such as central server 208 illustrated in FIG. 2. The service request may be transmitted via any known wired or wireless manner. Client computing devices may be any computing device such as a desktop computer, laptop, netbook, as well as any mobile computing device such as mobile (e.g., cellular) phones, media players, personal digital assistants (PDAs), and the like as also discussed above with reference to FIG. 1 and FIG. 2.

The client may transmit the service request by any known means. In one embodiment, the client device may go to a website, of central server and/or shipping server, and enter in any desired information to carry out or complete the service request. In another embodiment, an image, indicia, or code may be provided on at least one transport container. Client device may then use the image or code on the transport container to transmit the service request. For example, the transport container may have a bar code, QR code, or any other indicia that the client device may scan to transmit the service request. In another example, the client device may input a code on the transport container in the central server's website. By scanning or inputting the image, indicia, or code, the transport container may be associated with client device.

Departure location may be any location the client would like the at least one package picked up from. For example, departure location may be the client's home, hotel, airport, or any other desired location. Destination data based on the at least one destination location may be obtained at 304, the destination data including at least a destination address. Destination location may be any location the client would like the at least one package delivered to, such as a service provider. Departure location information and service provider information may be stored in a central database of central server. Departure location information stored in central database many include information or data such as contact information (e.g. address, telephone number, contact person, and the like), pick-up location or instructions for at least one package (e.g. location in or around the departure location where the at least one package will be stored for pick-up, whether the package is fragile, and the like), client information, detailed description of the at least one package (e.g. description of items in the package, color, shape, manufacturer, and the like), and any other information necessary or desired to facilitate pick-up of the at least one package. Destination location information may include information or data such as contact information (e.g. address, telephone number, contact person, and the like), pick-up or delivery instructions for at least one package (e.g. location in or around service provider location where the at least one package will be stored for pick-up, whether the package is fragile, and the like), client information, detailed description of the at least item or the at least one package (e.g. description of items in the package, color, shape, manufacturer, and the like), and any other information necessary or desired to facilitate completion of delivery of the at least one package requested from the client.

Central server may have a shipment manager configured to communicate with shipping server such as shipping server 206 illustrated in FIG. 2. Shipping server may be any company that performs shipping services such as UPS™, United States Postal Service, DHL™, FedEx™, common carrier, local delivery service, or any other company that provides similar services. Shipment manager may determine a charge amount at 306. In one embodiment, based on at least the departure location and destination location, shipment manager may determine a service charge for delivery of the at least one package. In another embodiment, the charge for delivery of the at least one package may be based on at least the departure location, destination location, and the number of packages to be picked-up and delivered. In still another embodiment, the charge for delivery of the at least one package may be based on at least the departure location, destination location, number of packages to be picked-up and delivered, weight of the package, and whether the special instructions requires additional costs.

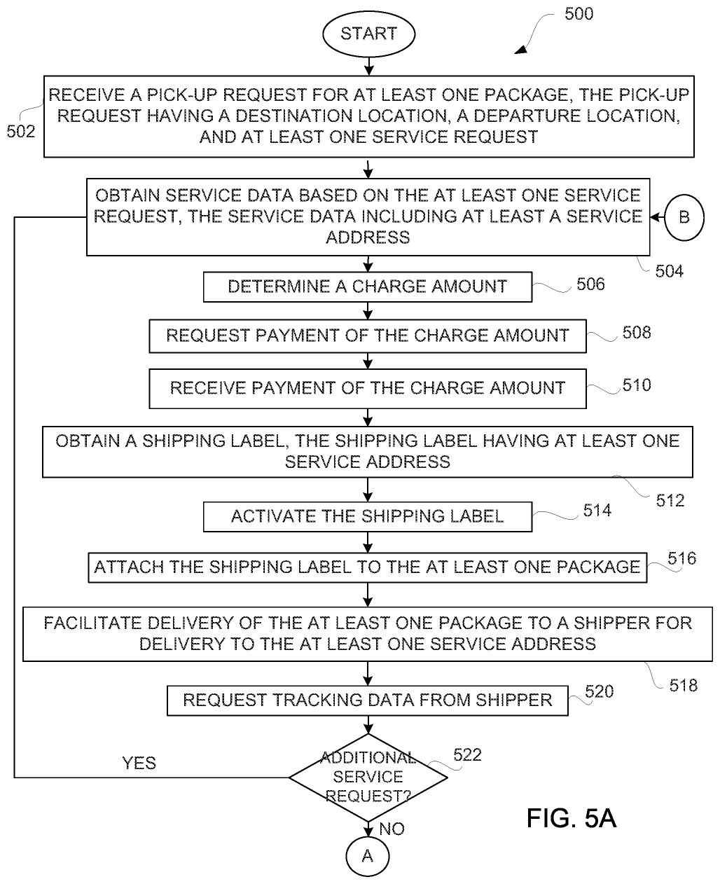

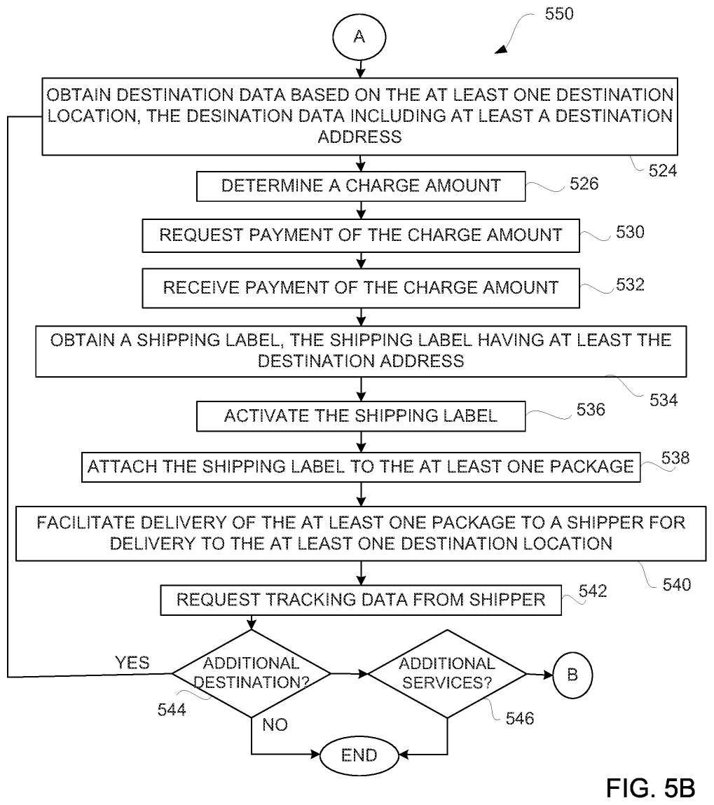

The service charge may also include any extra shipping services or shipping options such as the purchase of insurance, delivery confirmation, expedited delivery, and the like. The service charge may also include any service requests, as further discussed with reference to FIGS. 5A and 5B, requested by the client.

Once the service charge is calculated, an invoice or request for payment of the charge amount at 308 may be transmitted to the client. In one embodiment, client may provide payment to a payment manager, such as payment manager 224 of central server 208 illustrated in FIG. 2. In another embodiment, a third party payment server, such as third party payment server 226 illustrated in FIG. 2, may be used to provide payment. Although illustrated with the use of payment manager and third party payment server, this is not intended to be limiting as payment for the service charges may be conducted by other methods. For example, client may have the service charges charged to a credit card on file stored in a client information database in a central database.

When payment of the charge amount is received at 310, at least one shipping label may be obtained at 312, the at least one shipping label may have at least the destination location or address. The destination location may be printed as words or may be an image, such as a barcode or QR code, printed on the shipping label. In one embodiment, the at least one shipping label may be electronically delivered to departure location server. The shipping label may then printed and affixed or attached to the package at the departure location. In another embodiment, if there is more than one destination for the package, a plurality of shipping labels may be printed out and attached to the package. In still another embodiment, one shipping label may have multiple destination addresses printed on the single shipping label. In this embodiment, each destination address is printed on one shipping label and affixed to the package such that the service locations do not need to print any labels for efficiency. In yet another embodiment, a shipping label may be printed at each service provider server. The shipping label may be affixed or attached to the package at each servicer provider when the service is completed and the package is ready for shipment to the next destination. The service provider may recycle the original transport container or use a new transport container. The shipping label may be activated at 314 to be tracked. The shipping label may then be attached to the at least one package at 316.

The service request may just request that the at least one package be delivered to the client's home address. An employee from either the departure location or a shipping company may pick-up the at least one package to facilitate delivery of the at least one package to a shipper for delivery to the at least one destination location at 318.

Central server may store tracking information in the central database and request tracking data from shipper at 320. Whenever the at least one package is picked up and/or delivered, the shipping server may transmit tracking information or data for storage in central database. This provides for a chain of custody of the at least one package if it is lost or misplaced. Tracking information may include the name of the employee that picked up the at least one package, a timestamp of when the at least one package was picked up, a timestamp of when the at least one package was delivered, address of the pick-up and delivery locations, contact information of the person accepting delivery of the at least one package, and any other necessary or desired tracking information.

If there are additional destinations at 322, method 300 may obtain destination data at 304 and the method 300 may repeat. If there are no additional destinations at 322, method 300 may end.

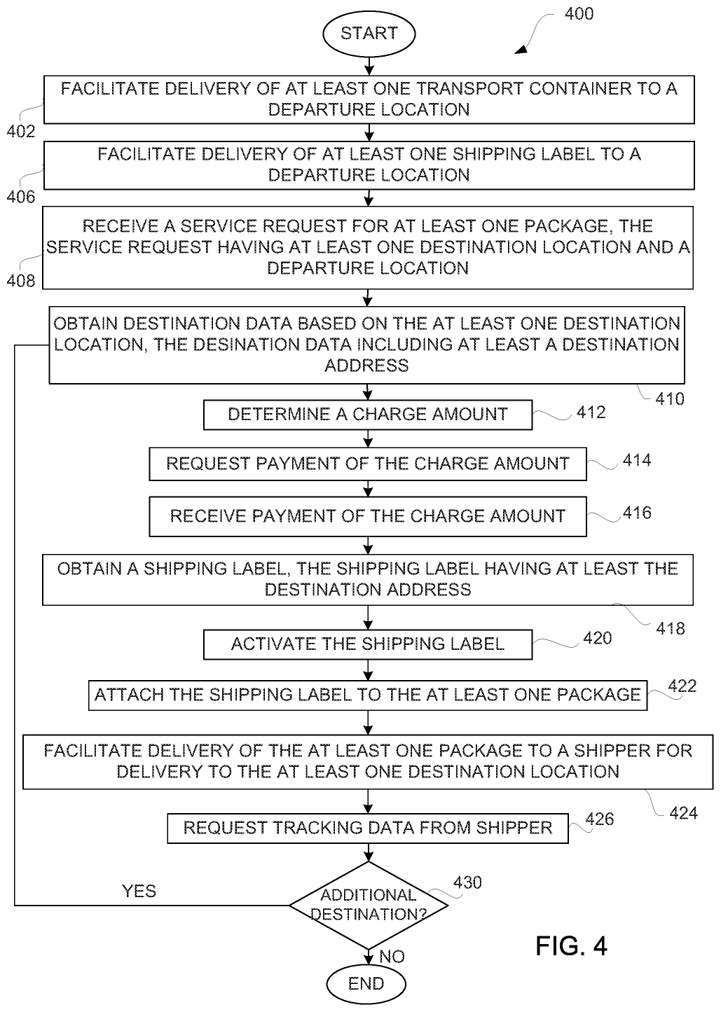

FIG. 4 illustrates another example ad-hoc auxiliary item transport method. The ad-hoc auxiliary item transport method provides for multiple destination transports using a pre-label and a departure location transport container. The method 400 is, in some instances, for use with an ad-hoc auxiliary item transport system, a memory storing data associated with one or more shipments, and one or more processors. The method 400 may be carried out, at least in part, by a portion of the system of FIG. 1 or FIG. 2, or using any combination of the components described.

Method 400 may begin with facilitating delivery of at least one transport container to a departure location at 402. In one embodiment, a plurality of transport containers may be provided to the departure locations or service providers. The transport containers may be used by clients, departure locations, or service providers to package or store the belongings for shipping. For example, if the client would like to ship their dirty clothes back home, they may put the dirty clothes in the transport containers rather than use their luggage. The transport container or package may then be picked up by an employee associated with the departure location and held until picked up by the shipping company. In another embodiment, the transport container may be picked up by an employee associated with a shipping company.

In one embodiment, the transport container may be customized to the departure location's or the service provider's specifications. The specifications may include, for example, a logo, tag lines, colors, and any other indicia necessary or desired by the departure location or the service provider to customize the transport container.

Delivery of at least one shipping label to a departure location may be facilitated at 406. Destination addresses and/or information may be pre-printed on the shipping label in accordance with a service request received from a client or customer. In another embodiment, the destination address and/or information may be printed on the shipping label at the departure location. The service request for at least one package may be received at 408, the service request having at least one destination location and a departure location. The service request may be transmitted from a client or customer device, such as client device 202a-n illustrated in FIG. 2, to a central server, such as central server 208 illustrated in FIG. 2. The service request may be transmitted via any known wired or wireless manner. Client computing devices may be any computing device such as a desktop computer, laptop, netbook, as well as any mobile computing device such as mobile (e.g., cellular) phones, media players, personal digital assistants (PDAs), and the like as also discussed above with reference to FIG. 1 and FIG. 2.

The client may transmit the service request by any known means. In one embodiment, the client device may go to a website, of central server and/or shipping server, and enter in any desired information to carry out or complete the service request. In another embodiment, an image, indicia, or code may be provided on at least one transport container. Client device may then use the image or code on the transport container to transmit the service request. For example, the transport container may have a bar code, QR code, or any other indicia that the client device may scan to transmit the service request. In another example, the client device may input a code on the transport container in the central server's website. By scanning or inputting the image, indicia, or code, the transport container may be associated with client device.

Departure location may be any location the client would like the at least one package picked up from. For example, departure location may be the client's home, hotel, airport, or any other desired location. Destination location data based on the at least on destination location, the destination data including at least a destination address at 410. Destination location may be any location the client would like the at least one package delivered to, such as a service provider. Departure location information and service provider information may be stored in a central database of central server. Departure location information stored in central database many include information or data such as contact information (e.g. address, telephone number, contact person, and the like), pick-up location or instructions for at least one package (e.g. location in or around the departure location where the at least one package will be stored for pick-up, whether the package is fragile, and the like), client information, detailed description of the at least one package (e.g. description of items in the package, color, shape, manufacturer, and the like), and any other information necessary or desired to facilitate pick-up of the at least one package. Destination location information may include information or data such as contact information (e.g. address, telephone number, contact person, and the like), pick-up or delivery instructions for at least one package (e.g. location in or around service provider location where the at least one package will be stored for pick-up, whether the package is fragile, and the like), client information, detailed description of the at least item or the at least one package (e.g. description of items in the package, color, shape, manufacturer, and the like), and any other information necessary or desired to facilitate completion of delivery of the at least one package requested from the client.

Central server may have a shipment manager configured to communicate with shipping server such as shipping server 206 illustrated in FIG. 2. Shipping server may be any company that performs shipping services such as UPS™, United States Postal Service, DHL™, FedEx™, common carrier, local delivery service, or any other company that provides similar services. Shipment manager may determine a charge amount at 412. In one embodiment, based on at least the departure location and destination location, shipment manager may determine a service charge for delivery of the at least one package. In another embodiment, the charge for delivery of the at least one package may be based on at least the departure location, destination location, and the number of packages to be picked-up and delivered. In still another embodiment, the charge for delivery of the at least one package may be based on at least the departure location, destination location, number of packages to be picked-up and delivered, weight of the package, and whether the special instructions requires additional costs.

The service charge may also include any extra shipping services or shipping options such as the purchase of insurance, delivery confirmation, expedited delivery, and the like. The service charge may also include any service requests, as further discussed with reference to FIGS. 5A and 5B, requested by the client.

Once the service charge is calculated, an invoice or request for payment of the charge amount at 414 may be transmitted to the client. In one embodiment, client may provide payment to a payment manager, such as payment manager 224 of central server 208 illustrated in FIG. 2. In another embodiment, a third party payment server, such as third party payment server 226 illustrated in FIG. 2, may be used to provide payment. Although illustrated with the use of payment manager and third party payment server, this is not intended to be limiting as payment for the service charges may be conducted by other methods. For example, client may have the service charges charged to a credit card on file stored in a client information database in a central database.

When payment of the charge amount is received at 416, at least one shipping label may be obtained at 418, the at least one shipping label may have at least the destination location or address. The destination location may be printed as words or may be an image, such as a barcode or QR code, printed on the shipping label. In one embodiment, the at least one shipping label may be electronically delivered to departure location server. The shipping label may then printed and affixed or attached to the package at the departure location. In another embodiment, if there is more than one destination for the package, a plurality of shipping labels may be printed out and attached to the package. In still another embodiment, one shipping label may have multiple destination addresses printed on the single shipping label. In this embodiment, each destination address is printed on one shipping label and affixed to the package such that the service locations do not need to print any labels for efficiency. In yet another embodiment, a shipping label may be printed at each service provider server. The shipping label may be affixed or attached to the package at each servicer provider when the service is completed and the package is ready for shipment to the next destination. The service provider may recycle the original transport container or use a new transport container. The shipping label may be activated at 420 to be tracked. The shipping label may then be attached to the at least one package at 422.

The service request may just request that the at least one package be delivered to the client's home address. An employee from either the departure location or a shipping company may pick-up the at least one package to facilitate delivery of the at least one package to a shipper for delivery to the at least one destination location at 424.

Central server may store tracking information in the central database and request tracking data from shipper at 426. Whenever the at least one package is picked up and/or delivered, the shipping server may transmit tracking information or data for storage in central database. This provides for a chain of custody of the at least one package if it is lost or misplaced. Tracking information may include the name of the employee that picked up the at least one package, a timestamp of when the at least one package was picked up, a timestamp of when the at least one package was delivered, address of the pick-up and delivery locations, contact information of the person accepting delivery of the at least one package, and any other necessary or desired tracking information.

If there are additional destinations at 430, method 400 may obtain destination data at 410 and the method 400 may repeat. If there are no additional destinations at 430, method 400 may end.

FIGS. 5A and 5B illustrate a flowchart of yet another example ad-hoc auxiliary item transport method. The method 500 provides for multiple destination transport using a printed label is shown. This method is, in some instances, for use with an ad-hoc auxiliary item transport system, a memory storing data associated with one or more shipments, and one or more processors. The method 500 may be carried out, at least in part, by a portion of the system of FIG. 1 or FIG. 2, or using any combination of the components described.

Referring to FIG. 5A, method 500 may begin with receiving a pick-up request for at least one package, the pick-up request having a destination location, a departure location, and at least one service request at 502. The pick-up request may be transmitted from a client or customer device, such as client device 202a-n illustrated in FIG. 2, to a central server, such as central server 208 illustrated in FIG. 2. The pick-up request may be transmitted via any known wired or wireless manner. Client computing devices may be any computing device such as a desktop computer, laptop, netbook, as well as any mobile computing device such as mobile (e.g., cellular) phones, media players, personal digital assistants (PDAs), and the like as also discussed above with reference to FIG. 1 and FIG. 2.

The client may transmit the pick-up request by any known means. In one embodiment, the client device may go to a website, of central server and/or shipping server, and enter in any desired information to carry out or complete the pick-up request. In another embodiment, an image, indicia, or code may be provided on at least one transport container. Client device may then use the image or code on the transport container to transmit the pick-up request. For example, the transport container may have a bar code, QR code, or any other indicia that the client device may scan to transmit the pick-up request. In another example, the client device may input a code on the transport container in the central server's website. By scanning or inputting the image, indicia, or code, the transport container may be associated with then client.

Departure location may be any location the client would like the at least one package to be picked up from, such as a personal residence, hotel, campground, or any other location. The destination location may be the locations where the client would like to have the at least one package delivered to, such as service provider 218a-n illustrated in FIG. 2. Departure location information and service provider information may be stored in a central database of central server. Departure location information stored in central database many include information or data such as contact information (e.g. address, telephone number, contact person, and the like), pick-up location or instructions for at least one package (e.g. location in or around the departure location where the at least one package will be stored for pick-up, whether the package is fragile, and the like), client information, detailed description of the at least one package (e.g. description of items in the package, color, shape, manufacturer, and the like), and any other information necessary or desired to facilitate pick-up of the at least one package. Destination location may be based on a service provider. Service provider information may include information or data such as contact information (e.g. address, telephone number, contact person, and the like), services provided, duration of time to complete a service, pricing for the service, pick-up location or instructions for at least one package (e.g. location in or around service provider location where the at least one package will be stored for pick-up, whether the package is fragile, and the like), client information, detailed description of the at least item or the at least one package (e.g. description of items in the package, color, shape, manufacturer, and the like), and any other information necessary or desired to facilitate completion of services and pick-up of the at least one package requested from the client. Service data based on the at least one service request may be obtained at 504, the service data including at least a service address of the service provider.

Central server may have a shipment manager configured to communicate with shipping server such as shipping server 206 illustrated in FIG. 2. Shipping server may be any company that performs shipping services such as UPS™, United States Postal Service, DHL™, FedEx™, common carrier, local delivery service, or any other company that provides similar services. Shipment manager may determine a charge amount at 506. In one embodiment, based on at least the departure location and destination location, shipment manager may determine a service charge for delivery of the at least one package. In another embodiment, the charge for delivery of the at least one package may be based on at least the departure location, destination location, and the number of packages to be picked-up and delivered. In still another embodiment, the charge for delivery of the at least one package may be based on at least the departure location, destination location, number of packages to be picked-up and delivered, weight of the package, and whether the special instructions requires additional costs.

The service charge may also include any extra shipping services or shipping options such as the purchase of insurance, delivery confirmation, expedited delivery, and the like. The service charge may also include any service requests, as further discussed below, requested by client. For example, if the client requests laundry services, the cost of the laundry services may be included in the service charge. In another example, if the client requests a laptop computer to be fixed, the cost of fixing the laptop computer may be included in the service charge. The service charges may be obtained from service provider information stored in the central database of central server.

Once the service charge is calculated, an invoice or request for payment of the charge amount at 508 may be transmitted to the client. In one embodiment, client may provide payment to a payment manager, such as payment manager 224 of central server 208 illustrated in FIG. 2. In another embodiment, a third party payment server, such as third party payment server 226 illustrated in FIG. 2, may be used to provide payment. Although illustrated with the use of payment manager and third party payment server, this is not intended to be limiting as payment for the service charges may be conducted by other methods. For example, client may have the service charges charged to a credit card on file stored in a client information database in a central database.

When payment of the charge amount is received at 510, at least one shipping label may be obtained at 512, the at least one shipping label may have at least the service location or address. The destination location may be printed as words or may be an image, such as a barcode or QR code, printed on the shipping label. In one embodiment, the at least one shipping label may be electronically delivered to departure location server. The shipping label may then printed and affixed or attached to the package at the departure location. In another embodiment, if there is more than one destination for the package, a plurality of shipping labels may be printed out and attached to the package. In still another embodiment, one shipping label may have multiple destination addresses printed on the single shipping label. In this embodiment, each destination address is printed on one shipping label and affixed to the package such that the service locations do not need to print any labels for efficiency. In yet another embodiment, a shipping label may be printed at each service provider server. The shipping label may be affixed or attached to the package at each servicer provider when the service is completed and the package is ready for shipment to the next destination. The service provider may recycle the original transport container or use a new transport container. The shipping label may be activated at 514 to be tracked. The shipping label may then be attached to the at least one package at 516.

An employee from either the departure location or a shipping company may pick-up the at least one package to facilitate delivery of the at least one package to a shipper for delivery to the at least one service address at 518.

Central server may store tracking information in the central database and request tracking data from shipper at 520. Whenever the at least one package is picked up and/or delivered, the shipping server may transmit tracking information or data for storage in central database. This provides for a chain of custody of the at least one package if it is lost or misplaced. Tracking information may include the name of the employee that picked up the at least one package, a timestamp of when the at least one package was picked up, a timestamp of when the at least one package was delivered, address of the pick-up and delivery locations, contact information of the person accepting delivery of the at least one package, and any other necessary or desired tracking information.

If there are additional destinations at 522, method 500 may obtain service data at 504 and the method 500 may repeat. If there are no additional destinations at 522, method 500 may continue with reference to FIG. 5B.

Referring now to FIG. 5B, method 550 may begin with obtaining a destination data based on the at least one destination location, the destination data including at least a destination address at 524. The client may desire to have the at least package shipped from one location to another without having any services performed on the items in the package. For example, a business client may want to have his luggage delivered to each hotel location he is traveling to. The business client may have a conference in San Diego, Calif. and want his luggage to be shipped from his home residence in Austin, Tex. to the hotel. Then, he may have another conference in Reno, Nev. two days later and want his luggage shipped from his hotel in San Diego, Ca to the hotel in Reno, Nev. Finally, the business client may want to have his luggage shipped to his home residence in Austin, Tx after the conference in Reno, Nev.

Shipment manager may determine a charge amount at 526. In one embodiment, based on at least the departure location and destination location, shipment manager may determine a service charge for delivery of the at least one package. In another embodiment, the charge for delivery of the at least one package may be based on at least the departure location, destination location, and the number of packages to be picked-up and delivered. In still another embodiment, the charge for delivery of the at least one package may be based on at least the departure location, destination location, number of packages to be picked-up and delivered, weight of the package, and whether the special instructions requires additional costs.

The service charge may also include any extra shipping services or shipping options such as the purchase of insurance, delivery confirmation, expedited delivery, and the like. The service charge may also include any service requests, as further discussed below, requested by client. For example, if the client requests laundry services, the cost of the laundry services may be included in the service charge. In another example, if the client requests a laptop computer to be fixed, the cost of fixing the laptop computer may be included in the service charge. The service charges may be obtained from service provider information stored in the central database of central server.

Once the service charge is calculated, an invoice or request for payment of the charge amount at 530 may be transmitted to the client. In one embodiment, client may provide payment to a payment manager, such as payment manager 224 of central server 208 illustrated in FIG. 2. In another embodiment, a third party payment server, such as third party payment server 226 illustrated in FIG. 2, may be used to provide payment. Although illustrated with the use of payment manager and third party payment server, this is not intended to be limiting as payment for the service charges may be conducted by other methods. For example, client may have the service charges charged to a credit card on file stored in a client information database in a central database.

When payment of the charge amount is received at 532, at least one shipping label may be obtained at 534, the shipping label may have at least the destination location or address. The destination location may be printed as words or may be an image, such as a barcode or QR code, printed on the shipping label. In one embodiment, the at least one shipping label may be electronically delivered to departure location server. The shipping label may then printed and affixed or attached to the package at the departure location. In another embodiment, if there is more than one destination for the package, a plurality of shipping labels may be printed out and attached to the package. In still another embodiment, one shipping label may have multiple destination addresses printed on the single shipping label. In this embodiment, each destination address is printed on one shipping label and affixed to the package such that the service locations do not need to print any labels for efficiency. In yet another embodiment, a shipping label may be printed at each service provider server. The shipping label may be affixed or attached to the package at each servicer provider when the service is completed and the package is ready for shipment to the next destination. The service provider may recycle the original transport container or use a new transport container. The shipping label may be activated at 536 to be tracked. The shipping label may then be attached to the at least one package at 538.

An employee from either the departure location or a shipping company may pick-up the at least one package to facilitate delivery of the at least one package to a shipper for delivery to the at least one destination location at 540.

Central server may store tracking information in the central database and request tracking data from shipper at 542. Whenever the at least one package is picked up and/or delivered, the shipping server may transmit tracking information or data for storage in central database. This provides for a chain of custody of the at least one package if it is lost or misplaced. Tracking information may include the name of the employee that picked up the at least one package, a timestamp of when the at least one package was picked up, a timestamp of when the at least one package was delivered, address of the pick-up and delivery locations, contact information of the person accepting delivery of the at least one package, and any other necessary or desired tracking information.

If there are additional destinations at 544, method 550 may repeat at 524. If there are no additional destinations at 522, a determination may be made as to whether there are any additional services at 546. Referring back to the business client example above, in another embodiment, before the at least one package is returned to his home in Austin, Tx, the business client may want to have is clothes cleaned and laundered. As such, there may be additional services requested at 546 and the method 500 may repeat at 504. If there are no additional services at 546, method 550 may end.

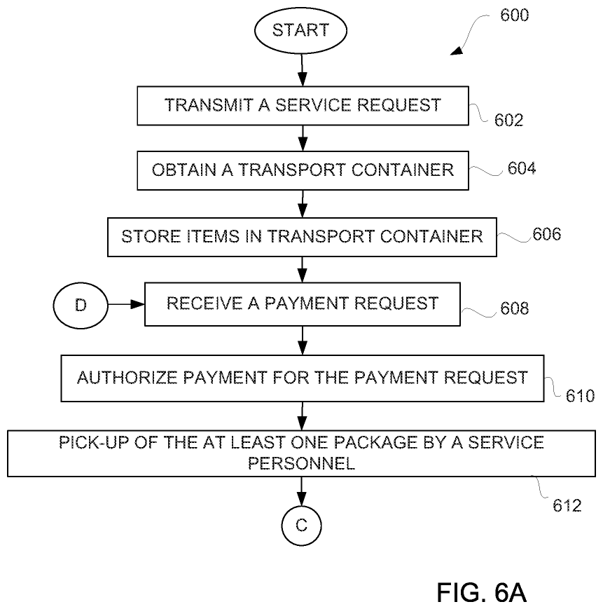

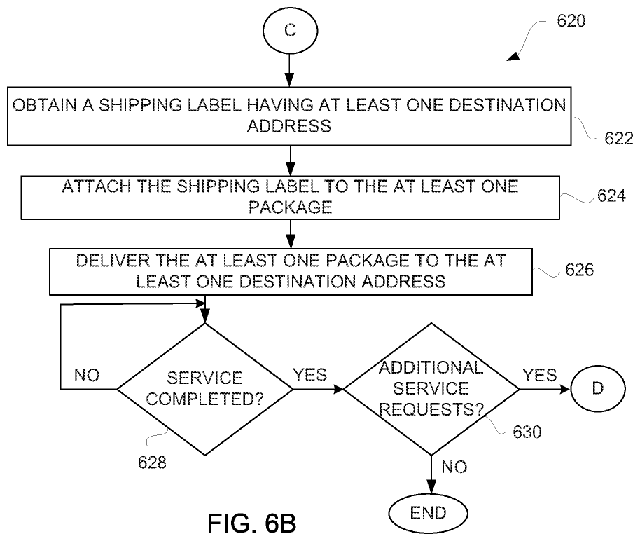

FIGS. 6A and 6B illustrate a flowchart of still another example ad-hoc auxiliary item transport method. Referring to FIG. 6A, the method 600 may begin with a client or customer transmitting a service request to a central server at 602. The service request may be a request to pick up and deliver at least one package and the request may include a service request to service at least one item in the at least one package.

The client may transmit the service request by any known means. In one embodiment, the client device may go to a website, of central server and/or shipping server, and enter in any desired information to carry out or complete the service request. In another embodiment, an image, indicia, or code may be provided on at least one transport container. Client device may then use the image or code on the transport container to transmit the service request. For example, the transport container may have a bar code, QR code, or any other indicia that the client device may scan to transmit the service request. In another example, the client device may input a code on the transport container in the central server's website. By scanning or inputting the image, indicia, or code, the transport container may be associated with client device.

A transport container may be obtained at 604 for the storage of items in the transport container at 606. In one embodiment, the client may have his own transport container, such as a luggage, sturdy bag, box, or any other container suitable for transport. In another embodiment, a plurality of transport containers may be provided to the departure location so that it is readily available to the clients. For example, hotels may place a transport container in each hotel room for the clients to package or store the belongings for shipping. For example, if the client would like to ship their dirty clothes back home, they may put the dirty clothes in the transport containers rather than use their luggage.

In one embodiment, the transport container may be customized to the departure location or the service provider specifications. The specifications may include, for example, a logo, tag lines, colors, and any other indicia necessary or desired by the departure location or the service provider to customize the transport container.

The client may receive a request for payment at 608. The central server may have a shipment manager configured to communicate with a shipping server via a network. Shipping server may be any company that performs shipping services such as UPS™, United States Postal Service, DHL™, FedEx™, common carrier, local delivery service, or any other company that provides similar services. In one embodiment, based on at least the departure location and destination location, shipment manager may determine a service charge for delivery of the at least one package. In another embodiment, the charge for delivery of the at least one package may be based on at least the departure location, destination location, and the number of packages to be picked-up and delivered. In still another embodiment, the charge for delivery of the at least one package may be based on at least the departure location, destination location, number of packages to be picked-up and delivered, weight of the package, and whether the special instructions requires additional costs.

The service charge may also include any extra shipping services or shipping options such as the purchase of insurance, delivery confirmation, expedited delivery, and the like. The service charge may also include any service requests, as also discussed above with reference to FIGS. 5A and 5B. For example, if the client requests laundry services, the cost of the laundry services may be included in the service charge. In another example, if the client requests a laptop computer to be fixed, the cost of fixing the laptop computer may be included in the service charge. The service charges may be obtained from service provider information stored in a central database.

Payment may be authorized at 610. In one embodiment, client may provide payment to a payment manager, such as payment manager 224 illustrated in FIG. 2. In another embodiment, a third party payment server 226 may be used to provide payment to central servicer 208. Although illustrated with the use of payment manager 224 and third party payment server 226, this is not intended to be limiting as payment for the service charges may be conducted by other methods. For example, client may have the service charges charged to a credit card on file stored in client information at a central database of central server.

The transport container or package may then be picked up by a service personnel at 612. In one embodiment, the transport container may be picked up by an employee associated with a shipping company. In another embodiment, the transport container may be picked up by an employee associated with the departure location and held until picked up by the shipping company.

Referring now to FIG. 6B, the method 620 begins with obtaining a shipping label having a destination or delivery address. The shipping label may then be activated and affixed or attached to the at least one package at 624. The at least one package may be delivered to the destination location based on the destination address on the shipping label at 626.

If the service request included a request for services, a determination may be made to determine whether the services are completed at 628. The determination may be made when central server and/or shipping company receives a completed notification from a service provider In another embodiment, the service provider may print a shipping label, which automatically notifies central server that the services are completed and notifies the shipping company that the at least one package is read to be picked up The completed notification may be transmitted by any known methods such as electronic mail, text message, use of the shipment company's or central server's web page, telephone call, or any other notification methods.

If services are completed at 628, a determination may be made to determine whether additional services are requested in the service request at 630. The determination may be based on the services requested in the service request. If additional services are requested at 630, the process may repeat at 608. If no additional services are requested at 630, the method 620 may end.

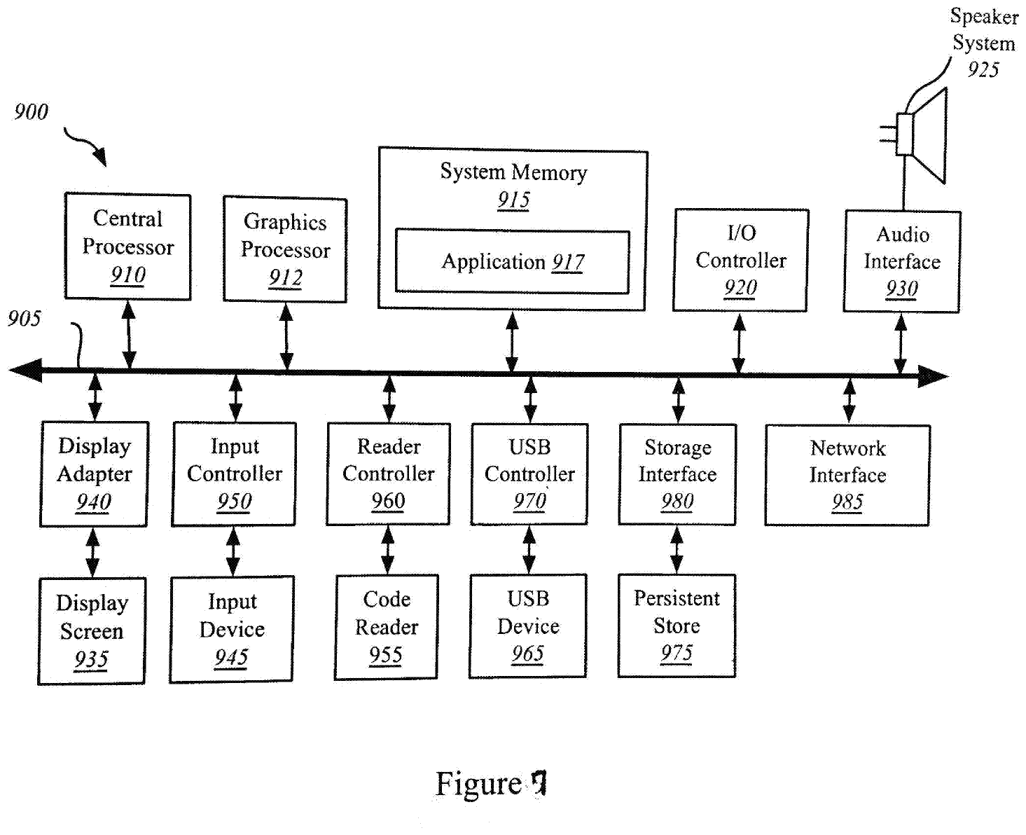

FIG. 7 illustrates a block diagram of a computing device according to one embodiment. The computing machine 900 may be an example of a computing device 105 (e.g., see FIG. 1), a machine running in the networked environment 170, or a machine running outside the networked environment 175. In one configuration, computing machine 900 includes a bus 905 which interconnects major subsystems of the computing machine 900, such as a central processor 910, a graphics processor 912, a system memory 915 (typically RAM, but which may also include ROM, flash RAM, or the like), an input/output controller 920, in some instances, one or more of an external audio device, such as a speaker system 925 via an audio output interface 930, an external device, such as a display screen 935 via display adapter 940, an input device 945 coupled to the bus 905 via one or more input controllers 950, one or more USB devices 965 coupled to the bus 905 via one or more USB controllers 970, a persistent data store 975 coupled to the bus 905 via a storage interface 980.

Bus 905 allows data communication between central processor 910, graphics processor 912, or both, and system memory 925, which may include read-only memory (ROM) or flash memory (neither shown), and random access memory (RAM) (not shown), as previously noted. The RAM is generally the main memory into which the operating system and application programs are loaded. The ROM or flash memory may contain, among other code, the Basic Input-Output system (BIOS), which controls basic hardware operation such as the interaction with peripheral components or devices. Engines and services resident with computing machine 900 are generally stored on and accessed via a non-transitory computer readable medium, such as a hard disk drive, solid state drive, or other storage medium. Additionally, applications may be in the form of electronic signals modulated in accordance with the application and data communication technology when accessed via a network interface 985.

Storage interface 980, as with the other storage interfaces of computing machine 900, may connect to a standard computer readable medium for storage and/or retrieval of information, such as a fixed disk drive, solid state drive, or the like 975. Persistent data store 975 may be a part of computing machine 900 or may be separate and accessed through other interface systems. Network interface 985 may provide a direct connection to a remote server or service. Network interface 985 may provide such connection using, for example, wired or wireless technologies, including but not limited to digital cellular telephone connection, Cellular Digital Packet Data (CDPD) connection, digital satellite data connection, or the like.

Many other devices or subsystems (not shown) may be connected in a similar manner (e.g., cameras, microphones, cell radio module, battery, and so on). Conversely, all of the components and interfaces shown in FIG. 9 need not be present to practice the present systems and methods. The devices and subsystems may be interconnected in different ways from that shown in FIG. 9. The aspect of some operations of a system such as that shown in FIG. 9 are readily known in the art and are not discussed in detail in this application. Computer instructions to implement the present disclosure may be stored in a non-transitory computer-readable medium such as one or more of system memory 915 or persistent store 975. The operating system provided on computing machine 900 may be, for example, MS-WINDOWS®, UNIX®, LINUX®, OSX®, iOS®, ANDROID®, MS-DOS®, or the like.

Certain embodiments of the invention are described with reference to methods, apparatus (systems) and computer program products that can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the acts specified herein to transform data from a first state to a second state.

These computer program instructions can be stored in a computer-readable memory that can direct a computer or other programmable data processing apparatus to operate in a particular manner, such that the instructions stored in the computer-readable memory produce an article of manufacture including instruction means which implement the acts specified herein. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified herein.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

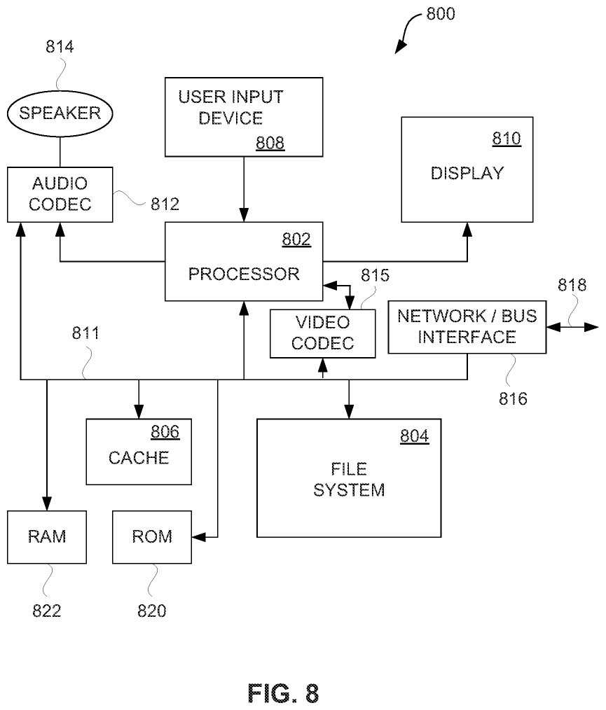

FIG. 8 illustrates a block diagram of a computing device 800 according to another embodiment. The computing device 800 can represent circuitry of a representative computing device (e.g. client device, central sever, shipping server, third party payment server, departure location server, service provider server) described and illustrated in FIG. 2. The computing device can be designed to primarily stationary or can be portable.

The computing device 800 includes a processor 802 that pertains to a microprocessor or controller for controlling the overall operation of the computing device 800. The computing device 800 stores media data pertaining to media items in a file system 804 and a cache 806. The file system 804 is, typically, semiconductor memory (e.g., flash memory) and/or one or more storage disks. The file system 804 typically provides high capacity storage capability for the computing device 800. However, since the access time to the file system 804 can be relatively slow, the computing device 800 can also include the cache 806. The cache 806 is, for example, Random-Access Memory (RAM). The relative access time to the cache 806 is typically shorter than for the file system 804. However, the cache 806 does not have the large storage capacity of the file system 804. The computing device 800 also includes a RAM 820 and a Read-Only Memory (ROM) 822. The ROM 822 can store programs, utilities or processes to be executed in a non-volatile manner. The RAM 820 provides volatile data storage, such as for the cache 806.

The computing device 800 may also include a user input device 808 that allows a user of the computing device 800 to interact with the computing device 800. For example, the user input device 808 can take a variety of forms, such as a button, keypad, dial, touch-sensitive surface, etc. Still further, the computing device 800 includes a display 810 (screen display) that can be controlled by the processor 802 to display information to the user. A data bus 811 can facilitate data transfer between at least the file system 804, the cache 806, the processor 802, an audio coder/decoder (CODEC) 812 and/or a video CODEC 815.

In one embodiment, for example, if the computing device 800 (e.g. client device 202a-n, departure location server 204a-n illustrated in FIG. 2) is a media player, the computing device 800 may store a plurality of media items (e.g., songs, videos, podcasts, etc.) in the file system 804. When a user desires to have the computing device play a particular media item, a list of available media items is displayed on the display 810. Then, using the user input device 808, a user can select one of the available media items. The processor 802, upon receiving a selection of a particular media item, supplies the media data to one or more appropriate output devices. If the particular media item is encrypted, the particular media item is first decrypted as noted above, which could involve one or more layers of encryption. As an example, for audio output, the processor 802 can supply the media data (e.g., audio file) for the particular media item to the audio CODEC 812. The audio CODEC 812 can then produce analog output signals for a speaker 814. The speaker 814 can be a speaker internal to the computing device 800 or external to the computing device 800. For example, headphones or earphones that connect to the computing device 800 would be considered an external speaker. As another example, for video output, the processor 802 can supply the media data (e.g., video file) for the particular media item to the video CODEC 815. The video CODEC 815 can then produce output signals for the display 810 and/or the speaker 814.

The computing device 800 also includes a network/bus interface 816 that couples to a data link 818. The data link 818 allows the computing device 800 to couple to another device (e.g., a host computer, a power source, or an accessory device). The data link 818 can be provided over a wired connection or a wireless connection. In the case of a wireless connection, the network/bus interface 816 can include a wireless transceiver.

The various aspects, features, embodiments or implementations of the invention described above can be used alone or in various combinations. Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures may be implemented to achieve the same functionality.

The process parameters and sequence of steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. An item transport management system, comprising:
at least one server having a processor configured to:
receive a pick-up request from a client device to pick up at least one package, the pick-up request including at least a departure location and at least one service request to service at least one item in the at least one package; and
transmit a service shipping label to the departure location, the service shipping label being used to direct the package to a service location.

2. An item transport management system as recited in claim 1, wherein the pick-up request includes the service location.

3. An item transport management system as recited in claim 1, wherein the pick-up request includes a criterion for use in selecting the service location.

4. An item transport management system as recited in claim 1, wherein the processor is configured to:
transmit a return shipping label to the service location, the return shipping label being used to direct the package to a return location, the return location being different than the departure location and the service location.

5. An ad-hoc auxiliary item transport system, comprising:
a central server having a processor configured to:
receive a pick-up request from a client device to pick up at least one package, the pick-up request including at least a departure location and at least one service request to service at least one item in the at least one package; and
determine a first destination address based on the at least one service request; and
a shipment server configured to:
determine a first charge amount based on the departure location, the first destination address, and the at least one service request;
transmit a first payment request to the client device for payment of the first charge amount;
receive a payment of the first charge amount;
transmit as shipping label to the departure location, the shipping label including the first destination address; and
transmit a first pick-up notification to a shipping server, the first pick-up notification including at least the first destination address.

6. The system of claim 5, wherein the central server is further configured to:
determine whether service of the at least one item is completed;
determine whether additional services are requested based on the pick-up request; and
determine a second destination address if it is determined that additional services are requested.

7. The system of claim 6, wherein the shipping manager is further configured to:
determine a second charge amount based on the departure location, the second destination address, and the at least one requested service;
transmit a second payment request to the client device for payment of the second charge amount;
receive a payment of the second charge amount;
transmit as shipping label to the departure location, the shipping label including the second destination address; and
transmit a second pick-up notification to a shipping server, the second pick-up notification including at least the second destination address.

8. The system of claim 5, wherein the first charge amount is based on a weight of each of the at least one packages.

9. The system of claim 5, wherein the at least one item in the at least one package is laundry to be cleaned, streamed. or ironed.
